(19) United States
(12) Patent Application Publication
(10) Pub. No.: US 2002/0148134 A1
(43) Pub. Date: Oct. 17, 2002

(54) Methods and apparatus for providing reference measurements

(76) Inventors: Paul A. Meyer, Evansville, IL (US); Donald R. McFadden SR., Chester, IL (US); Mark Valleroy SR., Evansville, IL (US)

Correspondence Address: John S. Beulick, Armstrong Teasdale LLP, One Metropolitan Sq., Suite 2600, St. Louis, MI, 63102, US

(21) Appl. No.: 09/836,730

(22) Filed: Apr. 17, 2001

(51) Int. Cl. G01B 3/10

(52) U.S. Cl. 33/758; 33/759; 33/494

(57) ABSTRACT

A tool that facilitates aligning members with respect to each other and an object is described. The tool includes a roll of material including an upper and a lower side. The material lower side includes adhesive material that enables the tool to be affixed to the object. The material upper side includes a plurality of reference markings arranged in a cyclic pattern that is repeated along an entire length of the tool. More specifically, adjacent reference markings are a pre-determined length apart that is selected depending on a desired alignment of the members to be aligned.

### BACKGROUND OF THE INVENTION

This application relates generally to measurement devices and, more particularly, to methods and apparatus for providing reference measurements.

Many assembly tasks require that members be aligned with respect to each other, as well as to an object. For example, during carpentry applications, often members must be aligned with respect to other members. More specifically, during construction of a wall, wall studs are secured to floor studs such that the wall studs are evenly spaced along the wall.

To facilitate equi-distant spacing between the wall studs, the wall assembly is often engineered and laid out to include reference markings in advance of assembly beginning. As assembly begins, frequent measurements are taken to ensure that any reference marks made while the assembly was laid out, are still accurate with respect to adjacent wall studs or to the floor studs.

Layouts with tape measures are limited to a length of the tape measure, and as such depending on a length of the wall, more than one person may be needed to lay out the assembly and to take the accuracy checks during the assembly. More specifically, during some construction assemblies, one person may be needed to hold the tape measure, while another person checks the reference marks on the wall or floor studs and makes new marks if necessary. The process is further complicated if the wall includes a plurality of windows or door frames, or if wall plates are to be mounted at standard building centers along the wall. As a result, the process may be time-consuming and costly to complete accurately.

### BRIEF SUMMARY OF THE INVENTION

In an exemplary embodiment, a tool provides reference markings to align a member with respect to an object in a cost-effective and reliable manner. The tool includes a roll of material including an upper and a lower side. The lower side includes adhesive material that enables the tool to be affixed to the object. The upper side includes a plurality of reference markings arranged in a pattern repeated along an entire length of the tool. More specifically, reference markings are selected such that adjacent members will be aligned a pre-determined length apart.

During use, a length of tool material is unwound and separated from the roll. The material portion selected is affixed to an object, such as a wall, and the members are aligned with respect to each other using the tool reference markings. As a result, the tool facilitates aligning the members in a cost-effective and timely manner.

### BRIEF DESCRIPTION OF THE DRAWINGS

FIG. 1 is perspective view of an exemplary embodiment of a tool;

FIG. 2 is an enlarged perspective view of a portion of the tool shown in FIG. 1;

FIG. 3 is perspective side view of the tool shown in FIG. 2 and placed in alignment position with a wall frame; and

FIG. 4 is a plan view of an alternative embodiment of a tool.

### DETAILED DESCRIPTION OF THE INVENTION

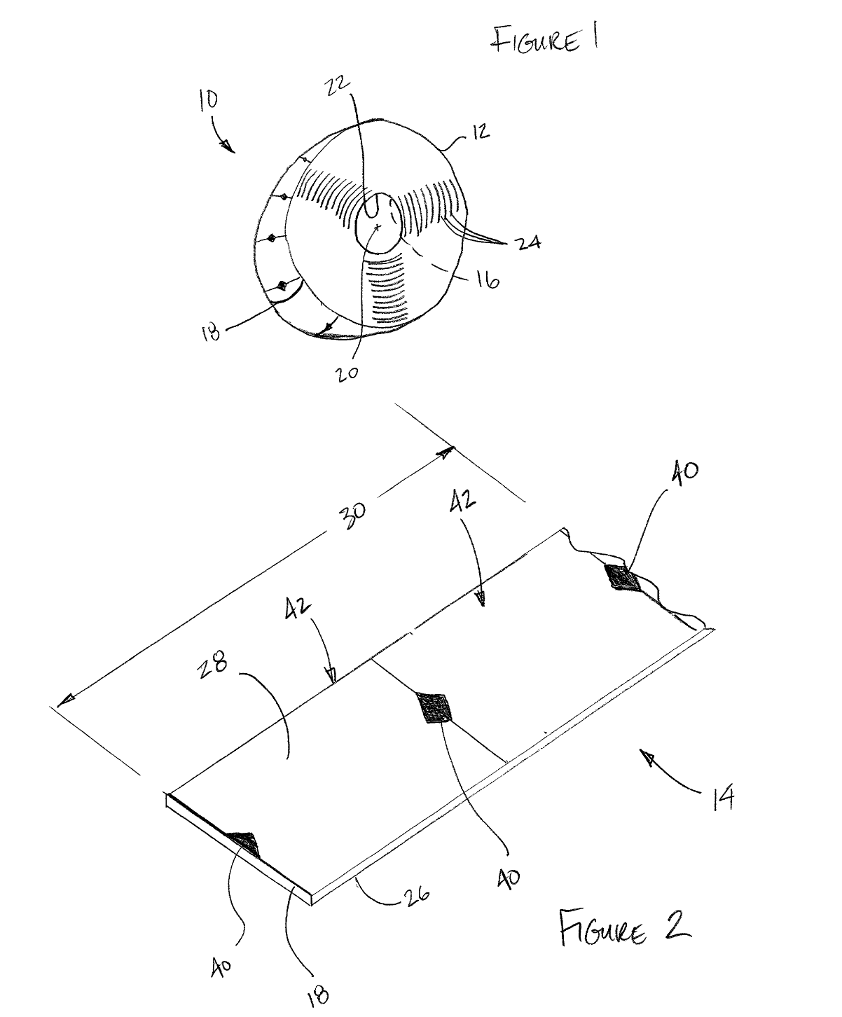

FIG. 1 is a perspective view of an exemplary embodiment of a tool 10 including a roll 12 of material. FIG. 2 is an enlarged perspective view of an unrolled material portion 14 of roll 12. Roll 12 has a first end 16 and a second end 18. First end 16 is adjacent a center 20 of roll 12, and second end 18 is radially outward from roll first end 16. More specifically, in the exemplary embodiment, first end 16 is initially placed against a roll core 22, and the material is circumferentially wound around first end 16 and center 20 in a counter-clockwise direction, such that each subsequent rotation produces a layer of windings 24 that is radially outward from a previous winding 24. In one embodiment, the tool material is not rolled, but rather is placed in a container (not shown) in a folded manner.

The tool material includes a bottom side 26 and an upper side 28. More specifically, material bottom side 26 includes an adhesive material. Alternatively, material sides 26 and 28 each include adhesive material. In one embodiment, at least one of sides 26 and 28 includes a non-stick surface that is removed from the material to expose the adhesive material. In another embodiment, at least one of sides 26 and 28 includes adhesive material that is activated after water is applied to the material. In a further embodiment, at least one of sides 26 and 28 includes hook fasteners for coupling to mating pile fasteners.

As roll second end 18 is moved circumferentially in a clockwise direction, a length 30 of roll material may be separated from windings 24. When a desired length 30 of material has separated from windings 24, the separated material is severed from roll 12 to form material portion 14. In one embodiment, the material is torn by hand. Alternatively, the material is cut with a cutting apparatus (not shown). Material portion length 30 is variably selected depending on the task requiring reference measurements. In one embodiment, tool roll 12 is a roll of tape, such as, but not limited to, masking tape, packing tape, duct tape, electrical tape, or wrapping tape. Alternatively, tool roll 12 is any suitable roll of tape which has at least one side 26 and 28 used to affix the material to an object (not shown in FIGS. 1 and 2).

Material upper side 28 includes a plurality of reference markings 40. More specifically, markings 40 are arranged in cyclic patterns 42 that extend along roll 12 between roll first and second ends 16 and 18, respectively. Adjacent markings 40 are spaced at preset distances 44 apart. In one embodiment, each reference marking 40 is identical with every other reference marking 40. Accordingly, because markings 40 are arranged in patterns 42, regardless of a material portion length 30 of the roll material selected, reference markings 40 may be included along portion 14.

Reference markings 40 include geometric symbols or shapes and are positioned to indicate various lengths 44 between adjacent markings 40. Because patterns 42 extend along an entire length of roll 12, various material portion lengths 30 may be removed from roll 12 without varying lengths 42 between adjacent markings 40 remaining on roll 12. In one embodiment, markings 40 are geometric shapes including, but not limited to, triangles, squares, ovals, diamonds, rectangles, or circles. In another embodiment, markings 40 are geometric symbols, including but not limited to, arrows or stars. In a further embodiment, markings 40 are alphabetic letters or typographical symbols. In yet a further embodiment, markings 40 include words, such as, “stud” or “center”. In another embodiment, within each pattern 42, reference markings 40 are numbered from one to sixteen.

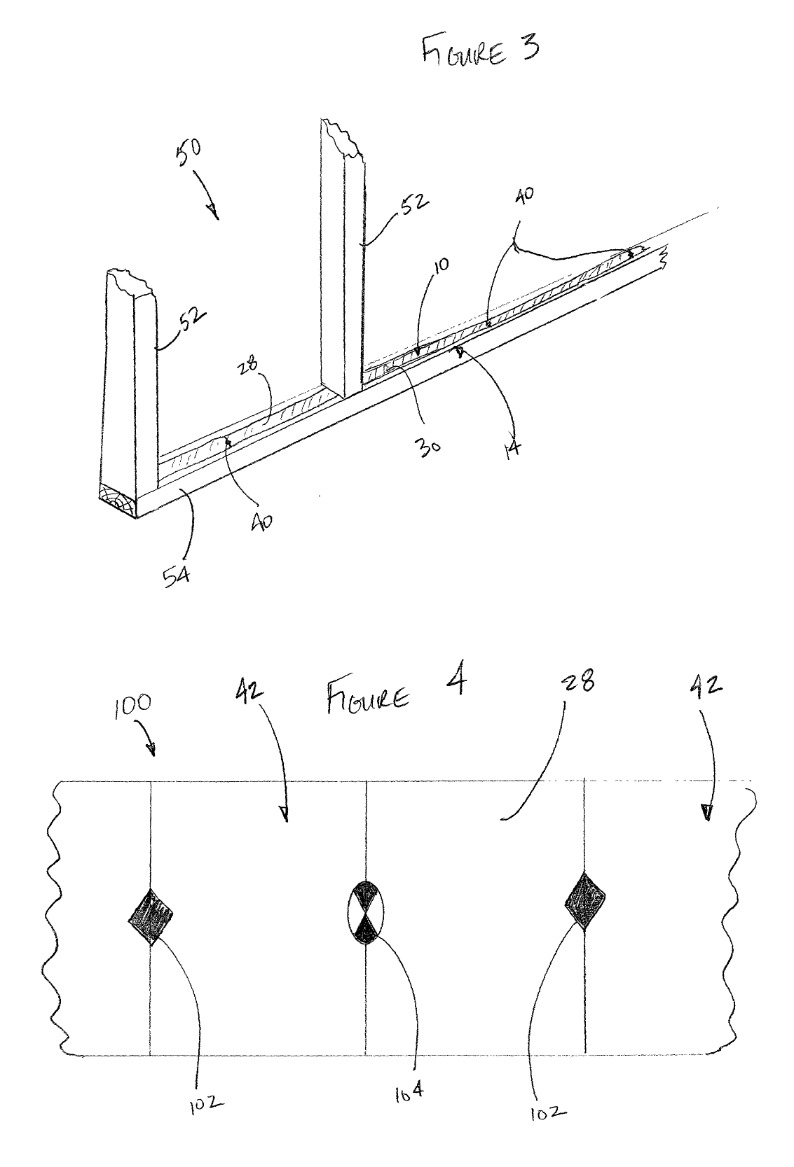

FIG. 3 is perspective side view tool 10 placed in alignment position for assembly of a wall frame assembly 50. Wall frame assembly 50 when assembled includes a plurality of wall studs 52 that extend substantially perpendicularly from a floor stud 54. More specifically, adjacent wall studs 52 are spaced equidistantly. Accordingly, as wall frame assembly 50 is being assembled, tool 10 is unwound and a material portion 14 of roll 12 is affixed to floor stud 54. Wall studs 52 are then positioned with respect to floor stud 54 using reference markings 40. More specifically, tool 10 ensures wall studs 52 are properly aligned with respect to each other such that adjacent studs 52 are evenly spaced.

In an alternative embodiment, a material length 30 of roll portion 14 is selected to correspond to a width (not shown) of an item (not shown), such as a framed picture. Roll portion 14 may then be affixed to a wall (not shown) to enable a person to select a hanging location and a midpoint for securing the item to the wall. In a further alternative embodiment, roll portion 14 is affixed to the wall to enable a person to more accurately hang curtain rods. In yet another embodiment, roll portion 14, is affixed to any item using accurate measurement references for positioning, aligning, sizing, spacing, or centering, including, but not limited to sewing applications, carpentry applications, plumbing applications, electrical wiring applications, remodeling applications, wall-papering applications, painting applications, or home do-it-yourself projects.

FIG. 4 is a plan view of an alternative embodiment of a tool 100. Tool 100 is substantially similar to tool 10, shown in FIGS. 1, 2, and 3, and components in tool 100 that are identical to components of tool 10 are identified in FIG. 4 using the same reference numerals used in FIGS. 1, 2, and 3. Accordingly, tool 100 includes roll 12 (shown in FIG. 1) of material including bottom side 26 (shown in FIG. 2) and upper side 28. Tool 100 material upper side 28 includes a plurality of reference markings 102 and 104. More specifically, markings 102 and 104 are arranged adjacent each other in cyclic patterns 42 that extend along roll 12 between roll first and second ends 16 and 18 (shown in FIG. 1), respectively. Accordingly, regardless of a material portion length 30 (shown in FIG. 2) selected, reference markings 102 and 104 may be included along portion 14.

Reference markings 102 and 104 are each substantially similar to reference markings 40, but within tool 100, reference markings 102 are different from reference markings 104. In the exemplary embodiment, each reference marking 104 is between adjacent reference markings 102. More specifically, each reference marking 104 is located at a midpoint between adjacent reference markings 102. In an alternative embodiment, a plurality of reference markings 104 are between adjacent reference markings 102 and indicate fractional distances other than a half, between adjacent reference markings 102, including, but not limited, to each eighth, each third, each quarter, or each fifth of the distance between adjacent reference markings 102.

The above described tool is cost-effective and reliable. The marking tool includes a roll of material including pre-selected reference markings. The reference markings correspond to desired distances between members to be aligned. Furthermore, the marking tool material includes adhesive material that enables the material to be self-sticking. Because the reference markings are arranged in cyclic patterns, the desired distances remain useful from a first end of the roll to the second end of the roll. As a result, alignment of members is facilitated in a cost-effective and reliable manner.

While the invention has been described in terms of various specific embodiments, those skilled in the art will recognize that the invention can be practiced with modification within the spirit and scope of the claims.

What is claimed is:

1. An apparatus for identifying reference measurements, said apparatus comprising tape comprising a first side and a second side, at least on of said first side and said second side comprises a plurality of reference markings configured to identify pre-selected distances.

2. Apparatus in accordance with claim 1 wherein at least one of said first side and said second side further comprises an adhesive material.

3. Apparatus in accordance with claim 2 wherein said tape comprises a roll of tape comprising an outer end and an inner end, said outer end radially outward from said inner end within said roll of tape, said reference markings extending between said roll of tape outer and inner ends.

4. Apparatus in accordance with claim 3 wherein said tape reference markings comprise only non-numeric markings.

5. Apparatus in accordance with claim 3 wherein said reference markings arranged in a pattern repeating between said roll of tape inner and outer ends.

6. Apparatus in accordance with claim 5 wherein each said tape reference mark is substantially identical to all other tape reference marks.

7. Apparatus in accordance with claim 2 wherein said tape reference markings comprise a plurality of first reference markings and a plurality of second reference markings, each said second reference marking halfway between adjacent first markings.

8. Apparatus in accordance with claim 2 wherein said tape first and second sides comprise adhesive material.

9. A tool for indicating a relative position of structural members with respect to other structural members, said tool comprising material comprising a first side and a second side, at least one of said material first side and said second side comprising a plurality of reference markings.

10. A tool in accordance with claim 9 wherein at least one of said material first side and said second side comprising adhesive material, said material reference markings comprise geometric symbols.

11. A tool in accordance with claim 10 wherein said material reference markings comprise a plurality of colors.

12. A tool in accordance with claim 10 wherein said material further comprises a roll of tape comprising a first end and a second end, said roll of material first end radially inward from said roll of tape second end, said material reference markings extending between said roll of material first and second ends.

13. A tool in accordance with claim 12 wherein said material reference markings arranged in a cyclic pattern extending between said roll of tape inner and outer ends.

14. A tool in accordance with claim 13 wherein each said material reference mark is substantially identical to all other material reference marks.

15. A tool in accordance with claim 13 wherein said tape reference markings comprise a plurality of first reference markings and a plurality of second reference markings, each said second reference marking halfway between adjacent first markings.

16. A tool in accordance with claim 10 wherein said material first and second sides each comprise adhesive material.

17. A method for identifying reference measurements using a tool to facilitate positioning a first member with respect to a second member, the tool including a roll of material having a first side and a second side, at least one of the material first and second side including adhesive, at least one of the material first and second side including a plurality of reference markings, said method comprising the steps of:
selecting a tool including reference markings at a desired distance apart that corresponds to a desired distance of separation of the first and second members;
unrolling a desired portion of the material from the roll;
affixing the desired material portion to an object using the material adhesive such that the reference markings are visible and extend along the object; and
positioning the first member with respect to the object using the material reference markings shown on the desired material portion.

18. A method in accordance with claim 17 wherein the material plurality of reference markings are arranged in cyclic patterns extending between a first end and a second end of the roll of material, and include only geometric shapes, said step of positioning the first member with respect to the material reference markings further comprising the step of using the material portion geometric shapes to position the first member with respect to the object.

19. A method in accordance with claim 18 wherein the material reference markings include a plurality of first geometric shapes and a plurality of second geometric shapes, said step of positioning the first member further comprising the steps of:
positioning the first member with respect to the object using the material reference marking first geometric shapes; and
positioning the second member with respect to the first member using the material reference marking second geometric shapes.

20. A method in accordance with claim 18 further comprising the steps of positioning at least the second member with respect to the first member using the material reference markings to ensure that the second member is spaced at desired distance from the first member.
